(19) United States
(12) Patent Application Publication
(10) Pub. No.: US 2008/0104128 A1
(43) Pub. Date: May 1, 2008

(54) SYSTEM AND METHOD FOR SECURE, ANONYMOUS, AND PERTINENT REPOSTING OF PRIVATE BLOG POSTING, ETC.

(76) Inventors: Jay A. Drayer, Houston, TX (US); Grant M. Howe, Cypress, TX (US)

Correspondence Address: FULBRIGHT & JAWORSKI, LLP, 1301 MCKINNEY, SUITE 5100, HOUSTON, TX, 77010-3095, US

(21) Appl. No.: 11/923,366

(22) Filed: Oct. 24, 2007

Related U.S. Application Data
(60) Provisional application No. 60/862,711, filed on Oct. 24, 2006.

(51) Int. Cl. G06F 17/30

(52) U.S. Cl. 707/200; 707/E17.005

(57) ABSTRACT

A system and method for anonymizing a user's private blog entries, and reposting the anonymized version to another pertinent blog. The system and method operable with a blog selection process for analyzing the user's private entry, user's preferences, uniform terms and codes, and indexed information from other blogs, in order to identify a pertinent public or private blog for reposting. The system and method are also operable with an anonymization process for purging personally identifiable information from the user's private blog post. The system and method are also operable with a posting process for reposting the anonymized blog entry.

### CROSS-REFERENCE TO RELATED APPLICATIONS

The present application claims priority to U.S. Provisional Patent Application Ser. No. 60/862,711, filed Oct. 24, 2006, which is incorporated by reference herein in its entirety.

### TECHNICAL FIELD

Embodiments of the present invention relate generally to on-line social networking. More particularly, embodiments of the present invention relate to anonymizing personally identifiable information in a user's blog post, and reposting an anonymous version of the blog post to a pertinent blog.

### BACKGROUND OF THE INVENTION

Social networking allows users to communicate online. Web logs (“blogs”) are a form of social networking. Blogs typically combine commentary or news on a particular topic from a variety of users, or function as personal online diaries. Blog posts, typically include text, images, links to other blogs, web pages, media, and other materials related to topics discussed in a blog. Blogs provide a powerful communication channel to exchange information about specific topics, including personal health, medical illness, and relationships, for example.

Blogs are growing in popularity. Part of their success arises by their ability to traverse logistical and social barriers. Through blogs, geographically disperse users (e.g., bloggers) connect and create vast quantities of rich information. Privacy of communication is often an important feature in blog sites. In fact, many blogs offer private discussion boards, locking out unregistered users or permitting users to choose community members. Under a sense of privacy, rich discussions of personal issues flow.

Users of private blogs often write about topics and have information that would be extremely useful to other people who are involved in the same scenario or circumstance, such as medical researchers, healthcare professionals, think tanks, legislative and policy professionals, content experts, the general public, etc. Unfortunately, information in private blogs is not even available to users who do not have access to the private blog.

To address the above and other problems in current social networking sites, an embodiment of the disclosed framework provides a system and method for identifying a pertinent blog, anonymizing a user's blog post, and reposting it to another blog.

### BRIEF SUMMARY OF THE INVENTION

One embodiment of the disclosed system provides a convenient and easy way for users to repost blog entries to external blogs that are on-topic or off-topic with their private posts. A user, who is a member in a social network, posts a blog entry on their or another member's site. Upon submitting the entry the user is presented with an opportunity to share this entry on other blogs. The user is presented with a pick list to select blogs to additionally post the entry. The pick list displays blogs which the user or the site owner are members, and/or blogs related to the current blog's topic. The user may also choose to post anonymously to these additional blogs.

Another embodiment of the system is illustrated by the following steps: User with an established online support community posts a blog entry to the system. User is presented with an option to repost to other blogs. User is presented with a list of allowable blogs to repost the entry to. These additional blogs are selected based on a number of criteria, including blogs that are associated with site medical diagnosis codes, blogs that are associated with the user, and blogs that are associated with keywords in the user's blog posting. User picks which blogs to repost the blog entry. User is presented with an option to anonymize the posting for public blogs. The anonymization process identifies words in the blog post that are found, or not found, in dictionaries. These are words that typically personalize a blog entry, such as people's names, places, and other identifying information. A list of words are then presented to, and selected by, the user for replacement. The system automatically posts entries to selected blogs.

In the preferred embodiment, the system comprises a cross posting engine operable to receive a blog post for a first blog and a cross posting request from a user, wherein the cross posting engine further comprises a blog selection process operable to selectively present at least one second blog to the user for cross posting, and receive a user selection of at least one second blog, an anonymization process operable to make the blog post anonymous, and a posting process operable to repost the blog post on the selected at lest one second blog.

In another embodiment, the blog selection process is operable to match the at least one second blog to at least one uniform term and/or uniform code. Alternatively, the blog selection process is operable to match the at least one second blog to at least one user preference. The blog selection process is optionally operable to match the at least one second blog to at least one user preferred blog. The blog selection process is also optionally operable to match the at least one second blog to at least one keyword.

In another embodiment, the anonymization process is operable to anonymize the blog post by selectively replacing words identified as personally identifiable information from the blog post with replacement words. The anonymization process is also optionally operable to anonymize by selectively replacing words not found in a public word repository with replacement words.

In another embodiment, the cross posting engine is operable to receive a private blog post for a first blog and a cross posting request from a user, wherein the cross posting engine further comprises: a blog selection process operable to selectively present at least one public blog to the user for cross posting, and receive a user selection of at least one second blog, an anonymization process operable to make the private blog post anonymous, and a posting process operable to repost the anonymized blog on the selected at lest one public blog.

In another embodiment, a method comprises receiving a blog entry for a first blog and a cross posting request from a user; selectively presenting at least one second blog to the user for cross posting; receiving a user selection of at least one second blog; making the blog entry on the selected at lest one second blog.

In another embodiment, the method further comprises identifying blogs associated with uniform codes and/or uniform terms; identifying blogs associated with user preferences; identifying blogs associated with keywords in the blog entry; and collecting the identified blogs and removing duplicate blogs.

In another embodiment, the step of identifying blogs associated with uniform codes and/or uniform terms, involves looking up diagnostic codes; optionally, the step of identifying blogs associated with user preferences, involves looking up user's preferred blogs;

In another embodiment, the method comprises identifying words in the blog entry that are not public words; present the identified words to the user for replacement; receiving user-selection of replacement words; and replacing the identified words with user-selected replacement words.

In another embodiment, the method comprises identifying words in the blog entry that are not public words involves looking up medical terms;

In another embodiment, the method comprises identifying words in the blog entry that are personally identifiable information; present the identified words to the user for replacement; receiving user-selection of replacement words; and replacing the identified words with user-selected replacement words.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

### BRIEF DESCRIPTION OF THE DRAWINGS

FIG. 1 is a simplified block diagram of a cross posting engine according to an embodiment of the system for secure, anonymous, and pertinent reposting of private blog posting to public blogs;

FIG. 2 is a flowchart of a blog selection process according to an embodiment of the system for secure, anonymous, and pertinent reposting of private blog posting to public blogs; and

FIG. 3 is a flowchart of an anonymization process according to an embodiment of the system for secure, anonymous, and pertinent reposting of private blog posting to public blogs.

### DETAILED DESCRIPTION OF THE INVENTION

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. It is also understood that, for purposes of clarity, like reference numerals identify like elements, structures and processes in each of the figures. The framework disclosed herebelow is preferably implemented by a computer executable program and/or hardware, according to practices known to those of ordinary skill in the art. It is to be appreciated that the processes described herein are instances of a computer program.

The disclosed framework addresses shortcomings of present blogs by providing a system and method for secure, anonymous, and pertinent reposting of private blog postings. Embodiments of the disclosed framework provide a cross posting engine 100, which is invoked by a cross posting request process 120, and operable with a blog selection process 140, for identifying other blogs to repost a user's blog post 110; an anonymization process 150, for anonymizing user's blog post 110; and, a posting process 160, for reposting to the user's entries to another blog post 130.

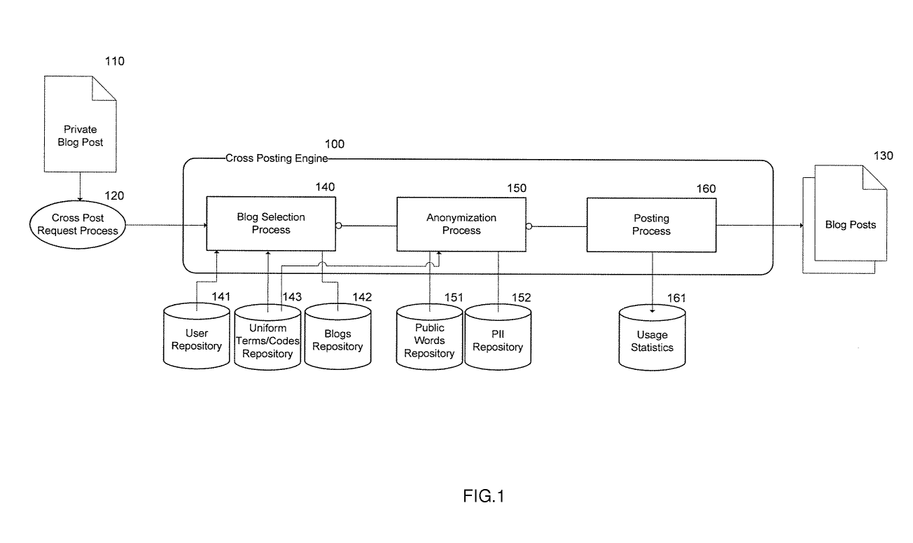

A blog displays the user's blog posts to the online community. Shown in FIG. 1, the online community is preferably a private blog, displaying the user's private blog posts 110. User's private blog posts 110 comprise one or more private entries preferably related to specific topics, and organized accordingly. Topics include news, personal health, relationships, medical circumstances, finance, food, games, health & diet, horoscopes, jobs, local happenings, geography, movies, music, people, photographs, real estate, shopping, sports, television, travel, art, videos, and technology, for example. A blog post is made up of user entries in the form of text, images, links, media (e.g., photographs, videos, software, music, etc.), or any other information that can be appended to the blog site.

In the preferred embodiment, the blog is “private” in the sense that posted information is not accessible to outsiders. To ensure privacy, the site preferably includes controls, operable by site administrators and/or users, that prevent release of personally identifiable information that would expose the identity of the user. The private blog thus provides users the ability to communicate privately with one another, without risk of exposure. In this secure environment, community members communicate freely, engaging in a different types of social networking with their online support community.

Through blog posts, community members create rich content, which often contain information applicable in other contexts/areas/fields. In general, the private blog post comprises two forms of entries: private words (e.g., personally identifiable information), and public words (e.g., non-personally identifiable information). Media appended in the private blog post typically includes, or is associated with, private and public words in the form of comments, source code, and metadata.

In the preferred embodiment, community members of the private blog have access to the user's private blog posts. In certain situations, however, users are interested in reposting their entries to other blogs accessible to non-community members. The system is therefore operable to provide users the option to repost their private entries to other blogs. At the user's option, the system is also operable to anonymize the user's private entries, before reposting.

Shown in FIG. 1, the cross post request process 120 is operable to present a user with the option to repost their private entries to other blogs, and receive an indication (yes/no) from the user indicating their preference. The user prompt is displayed before, after, or during the user's blog session, as desired. In the preferred embodiment, users opt to repost after submitting their blog post to the private blog.

In response to a “yes” indication, the cross post request process 120 executes to collect the user's private blog posts 110, thereby populating with all or a portion of the user's entry. Once a user's private blog post 110 is collected, the cross post request process 120 executes to parse private words and public words in the entry, and populate the cross post request engine 100 for further processing.

Shown in FIG. 1, the cross post request engine 100 is operable to carry out the user's request to repost. Once populated, the cross post request engine executes to select other blogs to repost user's private blog post, anonymize user's private blog post, and/or repost the user's blog post to the selected other blogs, as requested by the user.

The cross post request process 120 populates the cross posting engine 100 via the blog selection process 140. Shown in FIG. 1, the blog selection process 140 is one of three main sub-processes of the cross post request engine. The engine's other sub-processes, discussed below, include the anonymization process 150, and the posting process 160.

The blog selection process 140 is operable to select one of more other blogs pertinent to the user's private blog post. The blog selection process 140 provides for automatic and/or manual selection of pertinent blogs for reposting. In the preferred embodiment, pertinent blogs are automatically selected according to uniform terms/codes, user preferences, and/or keywords. Users preferably ultimately choose which sites to repost to. The blog selection process 140 preferably displays a prompt to the user proposing a list of pertinent blogs.

The blog selection process 140 accesses data in a variety of formats, from a plurality of sources, in compiling the list of pertinent blogs. In one embodiment, to compile the list of pertinent blogs, the blog selection process 140 accesses data from users, subscribed blogs, statistical charts, keyword lists, processes executing link algorithms, technology feeds, blog feeds, blog search engines, and search queries, for example. Such data is accessibly stored to the system for analysis.

In the preferred embodiment, data used to create a list of pertinent blogs is stored in the user repository 141, blogs repository 142, and uniform terms and code repository 142. own in FIG. 1, the user repository 141, blogs repository 142, and uniform terms/code repository 143 are all preferably storage mediums of a known sort, adapted with a database and structured collection of records for query by system processes. Shown in FIG. 1, the repositories preferably comprise separate (e.g., physically or logically separate) storage mediums, but may be integrated as desired. It is understood that the repositories may be distributed or centralized, and are preferably accessible by all system process, which may also be distributed or centralized for efficiency. In the preferred embodiment, the repositories are integrated in a database, system processes are centrally located, and blogs are widely dispersed across the web. During execution, the blog selection process 140 preferably accesses data stored in one of the main three repositories.

The user repository 141 preferably stores user preferences. User preferences comprise online and offline actions that indicate sites the user might be interested in reposting to. User preferences include any pursuits of the user including memberships to other online forums or websites, extracurricular activities, recreations, memberships and participation in organized groups, and personal or educational experiences, for example. User preferences also include any likings or habits including, by way of example, web sites visited, spending, gifts received, foods, manner of exercise, chemical substances, as well as geographic, religious, and economic preferences. In the preferred embodiment, a user's preferences indicate preferred blogs, which are stored in a preferred blog list. The user's preferred blog list includes websites known to the user, for example. The user's preferred blog list also includes sites where the user is a blogger, visitor, member, and/or contributor, for example.

The uniform terms and codes repository 143 preferably stores sets of uniform terminology and uniform codes. Uniform codes include any established sequence of characters, regularly used in a given field. Uniform terms are established words or phrases, regularly used in a given field. The uniform terms and codes preferably provide any unique identifier for concepts, medical diagnosis, products/services, medicines, insurance, financial services, special interests, advocacy programs, and healthcare providers, for example. Uniform terms and codes also preferably have applications in specific fields, such as healthcare and insurance for medical classifications or coding. In this context, uniform terms and codes preferably identify specific diseases, disorders, symptoms, medical signs, abnormal findings, complaints, social circumstances, external causes of injury or disease, and measure morbidity and mortality, for example.

In one embodiment, uniform codes include those published by World Health Organization, such as the International Classification of Diseases (“ICD”), for example. One example ICD code is ICD-11, however the preferred embodiment incorporates several ICD versions. Codes published by the American Psychiatric Association's (“APA”) and Diagnostic and Statistical Manual of Mental Disorders (“DSM”), also preferably populate the uniform codes and terms repository 143. The American Medical Association for Current Procedural Terminology (“CPT”), the Diagnosis-Related Group (“DRG”) for hospital cases, hospital emergency codes, and classifications for the International Classification of Primary Care (“ICPC”) provide further examples of stored uniform terms and codes. In another embodiment, stored uniform terms and codes include words, phrases, terms of art, etc., including medical terms and codes from sources such as the Medical Dictionary for Regulatory Activities (“MedDRA”). In another embodiment, uniform codes include Universal Product Codes (“UPC”), Global Trade Item Numbers (“GTIN”), and postal zip codes.

It will be appreciated that uniform terms and codes provide highly specific information about the user. Such information includes pertinent medical services and procedures, healthcare providers, similarly situated patients, accreditation organizations, and payers for administrative, financial services, religious topics, products, and localities among others.

The blogs repository 142 stores a list of blogs known to the system. One or more of such blogs may be pertinent to the user's blog post. The blog list preferably includes blogs for medical researchers, healthcare professionals, think tanks, legislative and policy professionals, content experts, and selected members of the general public, for example. The blog list also includes blogs directed to news, personal health, relationships, medical circumstances, finance, food, games, health & diet, horoscopes, jobs, local happenings, geography, movies, music, people, photographs, real estate, shopping, sports, television, travel, art, videos, and technology.

The blogs repository 142 indexes information posted to known sites. Indexed information is gathered by natural language searches, keywords, interactions or contributions of users, book marking, analysis of text or link structure of blog posts, tagging of content with descriptive labels, Boolean searches, and semantic searches, for example. Indexed information is also gathered from users, third-parties, system administrators, automated blog scrapers, technology feeds, and blog search engines, for example.

Shown in FIG. 1, and noted above, the user repository 160, blogs repository 142, uniform terms and codes repository, and other above noted sources, provide inputs to the blog selection process 140 for compiling a list of pertinent blogs. It is appreciated that any of such inputs, either alone or in combination, can be analyzed by the blog selection process 140 when compiling the list of pertinent sites.

For example, in one preferred embodiment, the blog selection process 140 analyzes uniform terms and codes to compile the list of pertinent sites. In doing so, the blog selection process 140 preferably executes queries to populate with uniform terms and codes stored in the uniform terms and codes repository 143. Once populated, the blog selection process 140 parses the user's private entries (e.g., private and public words), and compares the retrieved entries to uniform terms/codes (including related descriptions of the terms/codes) to identify matches. In a similar manner, the blog selection process 140 parses the indexed content from the other blogs, stored in the blogs repository 142, comparing such content with the retrieved uniform terms/codes to identify matches. When a uniform term or code is matched to both the user's entries and indexed content from another blog, that blog is considered to be pertinent, and it is stored to the pertinent blog list. It will be appreciate to those of skill in the art that different algorithms, varying in sophistication, can be implemented to determine matches between uniform terms and codes and the user's private entries and content from other blogs, as desired.

In another embodiment, the blog selection process 140 is operable to identify pertinent external blogs based on user preferences. To do so, the blog selection process 140 executes queries to the user repository 141 to retrieve the user's preferences and compare such preferences to indexed content for other blogs stored in the blog repository 142. It is appreciated that any user preference can be analyzed to identify other sites to repost the user's private entry. Blogs matching user preferences are preferably added to the pertinent blog list to update the list as needed.

In another embodiment, the blog selection process 140 queries the user repository 141 to retrieve the user's preferred blog list. Blogs in the user's preferred blog list are preferably automatically added the pertinent blog list. For efficiency, blogs in the user's preferred blog list can be reordered/sorted, such as when the user accepts/decline to repost their private entry to listed blogs, for example.

In another embodiment, the blog selection process 140 is operable to identify pertinent external blogs by matching keywords in the user's private entries with indexed keywords from other blogs. Keywords (e.g., descriptors) preferably capture the essence of the user's private entries, and external blog posts. Keywords can be a word, phrase, alphanumerical term, or a combination. Preferably, keywords provide search parameters to the blog selection process 140 when searching for pertinent sites. Retrieved sites are stored to the pertinent blog list. For improved accuracy, private and public words from the user's private blog provide inputs to the blog selection process 140 when creating keywords. It should be noted, however, that the keywords may also be generated from only private words, or only public words, as desired.

In other embodiments, pertinent blogs are selected by ranking a sites' bloggers, preparing/analyzing statistical charts to identify trends in keywords, and/or link algorithms (e.g., Hypertext Induced Topic Selection, PageRank, TrustRank, etc.), analyzing aggregate web-based news/topic blog content through technology feeds (e.g., Really Simple Syndication and Atom Syndication Formats), and analyzing individual blog feeds.

It is appreciated that any of the above embodiments, alone or in combination, are operable to identify pertinent blogs. Once the list of pertinent blogs is updated, the blog selection process 140 formats the list for presentation to user.

A user prompt is the preferred method of presenting the list of pertinent blogs to the user. For ease of use, the preferred blog list is sorted (e.g., alphasort, numsort, relevance, etc.). The blog selection process also applies weighting factors (determined by link algorithms, for example) and removes duplicates, prior to presentation for improved accuracy, as desired.

The preferred blog list is preferably presented to the user over a browser. Making their selection, the user preferably choose one or more of listed pertinent blogs where they would like to repost their private blog entry. The user is also presented with the option to anonymize their private entry via the prompt. Depending on the user's choice, the anonymization process 150 and/or posting process 160 is invoked.

Shown in FIG. 1, the anonymization process 150 is operable to anonymize the user's private entries from information/words indicating authorship. The anonymization process 150 anonymizes the user's entry by discriminating private and public words, then automatically or selectively substituting private words with replacement words. Replacement words are words that not disclose authorship information. In the preferred embodiment, the user decides which words are ultimately replaced, by entering the desired replacement words to the system via a user interface.

The anonymization process 150 identifies words indicating authorship by searching the user's private blog post for information considered to be personally identifiable information (“PII”). PII is known to one of skill in the field of online information security and privacy. The anonymization process 150 also identifies words indicating authorship by searching the user's private blog post for information considered to pubic words (e.g., not PII information).

Shown in FIG. 1, public words are stored in the public word repository 151. In this context, a public word includes any word appearing in a published dictionary (online or otherwise) that lists words (in any language) or combinations of words. Public words also include common misspellings of words, lemmas, grammatical information, word derivations, abbreviation, histories, etymologies, illustrations, usage, slang, idioms, expressions, sayings, etc. It is appreciated that in this context, a public words are generally any piece of information that cannot be used to identify the author/user, alone or in combination with other words. Public words may be a country, state, or city of residence, age, gender or race, name of the school, workplace, grades, salary, or job position, for example. Public words may also be comments, discussions, or other text that make up a user's private entry, not in the form of PII.

Also shown in FIG. 1, PII is stored in the PII repository 152. In this context, PII includes any information personally identifying the author/user. PII is also any piece of information which can potentially be used to contact, or locate a the user. Examples of PII include, but are not limited to, a person's full name (if not common), national identification number, telephone number, street address, e-mail address, IP address, vehicle registration plate number, driver's license number, face, fingerprints, handwriting, credit card numbers, digital identity.

Search parameters to the public word repository 151 and PII repository 152 are preferably in the form of words or combinations of words parsed from the user's private blog post 110. Executing searches, the anonymization process 150 preferably identifies words from the user's private blog post 110 that do not exist in the public dictionary repository 151, and marks those words as private words. The anonymization process 150 preferably stores words marked as private words in the private word list, presenting the list to user. Optionally, the anonymization process 150 presents a list of replacement words for the user to select. Replacement words may be any word. Replacement words can be pseudonyms, common names, random numbers, for example.

In another preferred embodiment, the anonymization process 150 preferably identifies words from the user's private blog post 110 that exist in the PII repository 152, and marks those words as private words. The anonymization process 150 preferably stores words marked as private words in the private word list, updating the list as needed.

The private word list is preferably presented to the user for replacement prior to reposting. The user preferably reviews the words in the private word list one by one for replacement, and selects a replacement word presented by the system, or enters their own replacement word, for each word in the list. Alternatively, the anonymization process 150 automatically purges private words from the user's private blog post, substituting the private words with predefine replacement words. After replacement, the user's private blog, now generally comprised of replacement words (in the place of private words) and public words, is considered anonymized and ready for reposting by the posting process 160.

Shown in FIG. 1, the posting process 160 is operable to repost the user's entries to other blog posts 130. It is noted that the posting process 160 can repost (i) an anonymized version of the user's private blog post, and/or (ii) the user's private blog post without first being anonymized. In the preferred embodiment, the posting process 160 reposts an anonymized version of the user's private blog.

The posting process 160 is operable with an application programming interface, generally known in the art, which executes to repost the user's blog post to the selected blogs. As desired, the posting process reposts the user's anonymized blog post to one or more blogs. The new blog post creates a new thread, or continues an existing thread, as appropriate.

The posting process 160 is operable to track information about the reposted blog posts 130, storing such information in the usage statistics repository 161. Tracked information may include clicks, hits, threads, responses, etc.

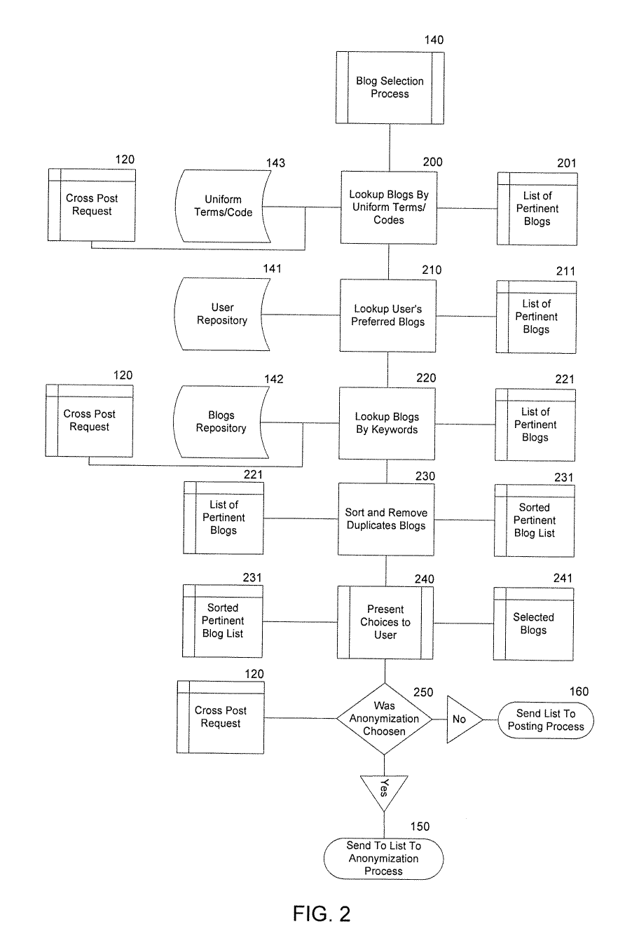

FIG. 2 shows an embodiment of the blog selection process executing steps of a preferred embodiment. The blog selection process 140 is invoked and populated by the cross post request 120 to perform three steps to identify pertinent blogs to repost the user's private blog post (not shown). In the first step, the blog selection process 140 looks up blogs by uniform codes terms and codes 200 stored in the uniform terms and codes repository 143. If a uniform code or term associated with the user's private post (supplied from the cross post request 120) matches a uniform code or term associated with an indexed blog, that blog is added to the list of pertinent blogs 201. In the second step, the blog selection process 140 looks up the user's preferred blogs 210 in the user repository 141, and updates the list of pertinent blogs 211 with the user's preferred blog list. In the third step, the blog selection process 140 looks up blogs by keywords 220 indexed in the blogs repository 142. If a keyword associated with the user's private post (supplied from the cross post request 120) matches a keyword associated with an indexed blog, that blog is added to the list of pertinent blogs 221.

At this point the list of pertinent blogs is assumed to be updated, and the blog selection process 140 sorts and removes duplicate blogs 230 in the list of pertinent blogs 221, to create a sorted pertinent blog list 231. Presenting choices to the user 240, the blog selection process displays the sorted pertinent blog list 231, and receives the user's blog choices to create a list of selected blogs 241. If anonymization was chosen 250, the blog selection process 140 and cross post request process 120 send the list of selected blogs to the anonymization process 150, along with other needed data. If anonymization was not chosen 250, the blog selection process 140 and cross post request process 120 send the list to the posting process 160, along with other needed data.

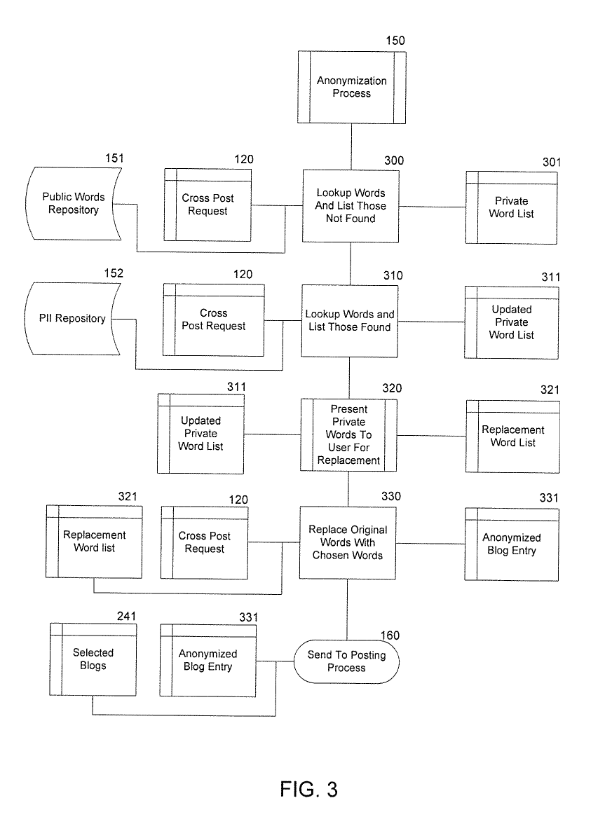

FIG. 3 shows an embodiment of the anonymization process 160 executing steps of the preferred embodiment as follows. Using the user's private blog entries as search parameters (supplied from the cross post request 120), the anonymization process 150 executes to lookup words, and list those not found 300 stored in the public words repository 151 within a private word list 301. Using the user's private blog entries as search parameters (supplied from the cross post request 120), the anonymization process 150 also executes to lookup words, and list those found 310 stored in the PII repository 151 within an updated private word list 311.

At this point, the anonymization process 160 presents the updated private word list to the user for replacement 320. Depending on which words the user chooses to remove from the updated private word list 311, the anonymization process 160 creates a replacement word list 321. Next, using the replacement word list 321, and user's private blog entry (supplied from the cross post request 120), the anonymization process replaces original words with chosen words 330 to create the anonymized blog entry 331. As a final step, the anonymization process 180 sends to the posting process 160 the anonymized blog entry 331, and list of selected blogs 241 for appropriate resposting(s).

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A system comprising:
A cross posting engine operable to receive a blog post for a first blog and a cross posting request from a user, wherein the cross posting engine further comprises:
a blog selection process operable to selectively present at least one second blog to the user for cross posting, and receive a user selection of at least one second blog,
an anonymization process operable to make the blog post anonymous, and
a posting process operable to repost the blog post on the selected at lest one second blog.

2. The system of claim 1 wherein the blog selection process is operable to match the at least one second blog to at least one uniform term and/or uniform code.

3. The system of claim 1 wherein the blog selection process is operable to match the at least one second blog to at least one user preference.

4. The system of claim 1 wherein the blog selection process is operable to match the at least one second blog to at least one user preferred blog.

5. The system of claim 1 wherein blog selection process is operable to match the at least one second blog to at least one keyword.

6. The system of claim 1 wherein the anonymization process is operable to anonymize the blog post by selectively replacing words identified as personally identifiable information from the blog post with replacement words

7. The system of claim 1 wherein the anonymization process is operable to anonymize by selectively replacing words not found in a public word repository with replacement words.

8. A system comprising:
a cross posting engine operable to receive a private blog post for a first blog and a cross posting request from a user, wherein the cross posting engine further comprises:
a blog selection process operable to selectively present at least one public blog to the user for cross posting, and receive a user selection of at least one second blog,
an anonymization process operable to make the private blog post anonymous, and
a posting process operable to repost the anonymized blog on the selected at lest one public blog.

9. A method comprising:
receiving a blog entry for a first blog and a cross posting request from a user; selectively presenting at least one second blog to the user for cross posting; receiving a user selection of at least one second blog; making the blog entry on the selected at lest one second blog.

10. The method of claim 9, further comprising:
identifying blogs associated with uniform codes and/or uniform terms; identifying blogs associated with user preferences; identifying blogs associated with keywords in the blog entry; and collecting the identified blogs and removing duplicate blogs.

11. The method of claim 9, wherein the identifying blogs associated with uniform codes and/or uniform terms, involves looking up diagnostic codes;

12. The method of claim 9, wherein the identifying blogs associated with user preferences, involves looking up user's preferred blogs;

13. The method of claim 9, further comprising:
identifying words in the blog entry that are not public words; present the identified words to the user for replacement; receiving user-selection of replacement words; and replacing the identified words with user-selected replacement words.

14. The method of claim 13, wherein identifying words in the blog entry that are not public words involves looking up medical terms;

15. The method of claim 9, further comprising:
identifying words in the blog entry that are personally identifiable information; present the identified words to the user for replacement; receiving user-selection of replacement words; and replacing the identified words with user-selected replacement words.
